(19) United States
(12) Patent Application Publication
(10) Pub. No.: US 2009/0322682 A1
(43) Pub. Date: Dec. 31, 2009

(54) INPUT APPARATUS

(75) Inventors: HUNG-BIN WU, Tu-Cheng (TW); YU-RONG LIU, Shenzhen City (CN); JIAN-HUA LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/485,938

(22) Filed: Jun. 17, 2009

(30) Foreign Application Priority Data
Jun. 26, 2008 (CN) 200810302324.5

(51) Int. Cl. G06F 3/033

(52) U.S. Cl. 345/163

(57) ABSTRACT

An input apparatus includes a main body, at least one input button and a scrolling component. The main body has a first surface, a second surface and a third surface extending from opposite edges of the first surface correspondingly. The at least one input button is mounted at the second surface. The scrolling component is mounted at the third surface and adjacent to the first surface.

### BACKGROUND

1. Technical Field

The present disclosure relates to input apparatus, and particularly to a hand-held input apparatus.

2. Description of Related Art

A typical mouse includes a housing, a detector disposed at a bottom side of the housing, two input buttons and a scroll wheel disposed at a top side of the housing. In use, the mouse directs a cursor to move correspondingly about a computer screen when slides along a flat surface. However, the mouse is not convenient because use of the mouse depends on being on the flat surface.

Therefore, there is room for improvement within the art.

### BRIEF DESCRIPTION OF THE DRAWINGS

FIG. 1 is an isometric view of an input apparatus in accordance with an exemplary embodiment.

FIG. 2 is another isometric view of the input apparatus in FIG. 1.

FIG. 3 is an isometric view of the input apparatus in FIG. 1 used as a pointing device.

### DETAILED DESCRIPTION

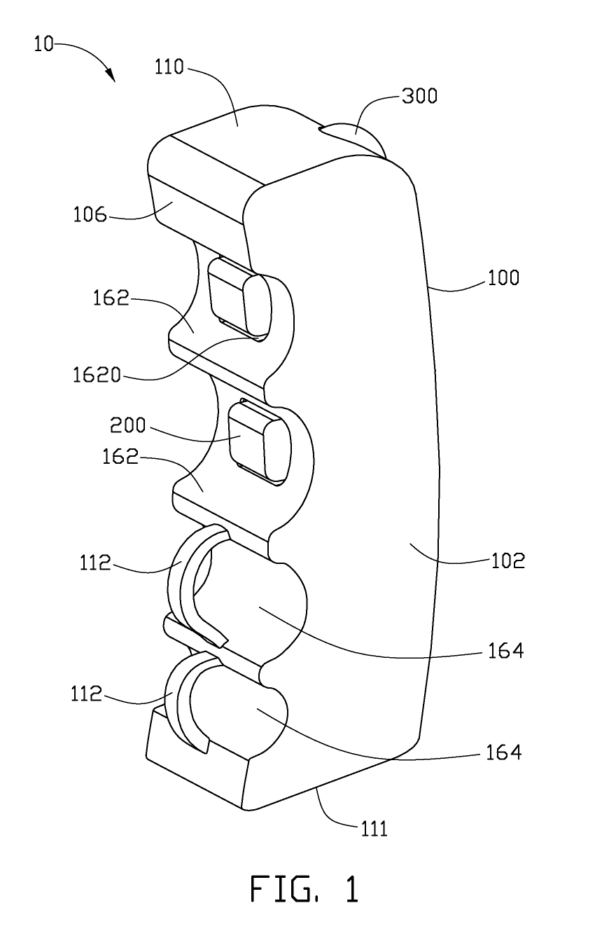

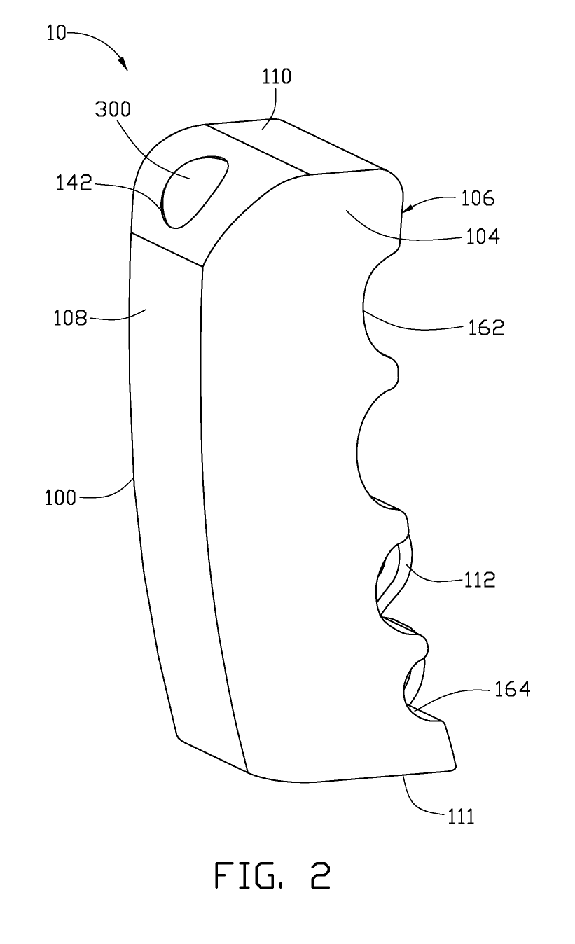

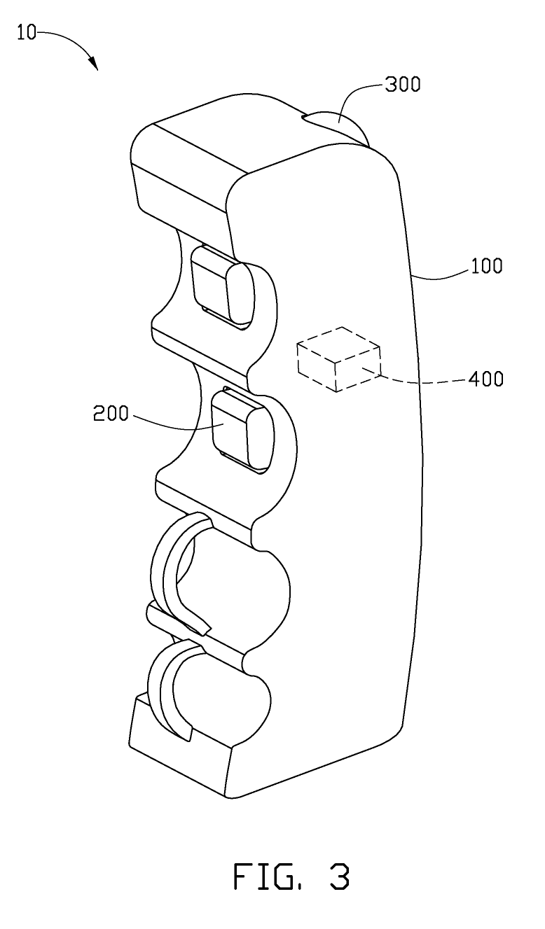

Referring to FIGS. 1 and 2, a hand-held input apparatus 10 includes a main body 100, two input buttons 200, and a scrolling component 300 disposed on the main body 100. The hand-held input apparatus 10 may be used as a pointing device e.g. a mouse which further includes a position detector 400 (referring to FIG. 3).

The main body 100 is substantially a handlebar grip with six surfaces i.e. a first surface 110, a second surface 106, a third surface 108, a fourth surface 104, a fifth surface 102, and a sixth surface 111. The second surface 106 and the third surface 108 are on opposite sides of the main body 100. The first surface 110, the fourth surface 104, the fifth surface 102, and the sixth surface 111 interconnect with each other, and all obliquely connect with the second surface 106 and the third surface 108. The fifth surface 102 is parallel to the fourth surface 104.

The third surface 108 curvedly connects to the first surface 110. The third surface 108 defines a first opening 142 for partially accommodating the scrolling component 300. The scrolling component 300 is adjacent to the first surface 110.

The second surface 106 is substantially a wavy surface. Two arched first receiving portions 162 and two arched second receiving portions 164 are recessed inward from the second surface 106. The two first receiving portions 162 and the two second receiving portions 164 are arranged linearly. The two first receiving portions 162 are adjacent to the first surface 110, while the two second receiving portions 164 are away from the first surface 110.

Each first receiving portion 162 defines a second opening 1620. The input buttons 200 are partially received in the main body 100 and protrude out of the first receiving portions 162 via the second opening 1620 correspondingly.

The main body 100 also includes two arched blocking members 112 across the two second receiving portions 164 correspondingly. Two straight edges of each blocking member 112 connect with two straight edges of the corresponding second receiving portion 164 and arch away from two curved edges of the corresponding second receiving portion 164.

The position detector 400 may be a tri-axis accelerator arranged in the main body 100. The position detector 400 is used for detecting positional shifts of the input apparatus 10. Correspondingly, a cursor moves about a computer screen according to the positional shifts of the input apparatus 10. The input apparatus 10 may be connected to a computer host via a wired or wireless connection.

In use, the main body 100 is handheld and a flat surface is not required. The two first receiving portions 162 receive the index finger and the middle finger correspondingly to operate the two input buttons 200. The two second receiving portions 164 receive the ring finger and the little finger correspondingly. The two blocking members 112 secure the ring finger and the little finger correspondingly, thus the input apparatus 10 does not slide out of the hand easily. The scrolling component 300 is controlled by the thumb.

In addition, the fifth surface 102 and the fourth surface 104 obliquely connect with the second surface 106 and the third surface 108. Thus the input apparatus 10 can be conveniently held and free of the requirement of the flat surface.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An input apparatus comprising:
a main body capable of being held by a user, the main body having a first surface, a second surface and a third surface extending from opposite edges of the first surface correspondingly;
at least one input button mounted at the second surface; and
a scrolling component mounted at the third surface and adjacent to the first surface.

2. The input apparatus according to claim 1, wherein the third surface is curvedly connected to the first surface.

3. The input apparatus according to claim 1, wherein the second surface is a wavy surface that includes two arched first receiving portions adjacent to the first surface and two arched second receiving portions away from the first surface; and the two first receiving portions and two second receiving portions are recessed inward from the second surface.

4. The input apparatus according to claim 3, wherein the two first receiving portions and two second receiving portions are arranged linearly.

5. The input apparatus according to claim 3, wherein the at least one input button is two input buttons; and the two input buttons are arranged in the two first receiving portions.

6. The input apparatus according to claim 3, wherein the main body comprises at least one arched blocking member crossing the second receiving portions; and two straight edges of the blocking member connect with two straight edges of the second receiving portions and arch away from two curved edges of the second receiving portions.

7. The input apparatus according to claim 1, wherein the first surface obliquely connects with the second surface and the third surface.

8. An input apparatus comprising:
a main body;
a scrolling component arranged at a first side of the main body; and
two input buttons arranged at a second side opposite to the first side of the main body.

9. The input apparatus according to claim 8, wherein a partially curved surface is formed on the first side.

10. The input apparatus according to claim 8, wherein a wavy surface is formed on the second side; the wavy surface includes two arched first receiving portions adjacent to the first side and the two arched second receiving portions away from the first side; and the two first receiving portions and the two second receiving portions are recessed inward from the second side.

11. The input apparatus according to claim 10, wherein the two first receiving portions and the two second receiving portions are arranged linearly.

12. The input apparatus according to claim 10, wherein the two input buttons are arranged in the two first receiving portions correspondingly.

13. The input apparatus according to claim 10, wherein the main body comprises two arched blocking member crossing two second receiving portions; and two straight edges of each blocking member connect with two straight edges of the corresponding second receiving portions and arch away from two curved edges of the corresponding second receiving portions.

14. A pointing device comprising:
a housing having a first surface, a second surface and a third surface extending from opposite edges of the first surface correspondingly;
a scrolling component mounted at the third surface and adjacent to the first surface;
two input buttons mounted at the second surface; and
a position detector detecting positional shifts of the pointing device.

15. The pointing device according to claim 14, wherein the pointing device is a mouse.

16. The pointing device according to claim 14, wherein the second surface is a wavy surface that includes two arched first receiving portions adjacent to the first surface and two arched second receiving portions away from the first surface; and the two first receiving portions and the two second receiving portions are recessed inward from the second surface.

17. The pointing device according to claim 16, wherein the two first receiving portions and the two second receiving portions are arranged linearly.

18. The pointing device according to claim 16, wherein the two input buttons are arranged in the two first receiving portions.

19. The pointing device according to claim 16, wherein the housing comprises at least one arched blocking member crossing the second receiving portions; and two straight edges of the at least one blocking member connect with two straight edges of the second receiving portions and arch away from two curved edges of the second receiving portions.

20. The pointing device according to claim 14, wherein the first surface obliquely connects with the second surface and the third surface.
